(19) United States
(12) Patent Application Publication
(10) Pub. No.: US 2024/0083795 A1
(43) Pub. Date: Mar. 14, 2024

(54) APPARATUS AND PROCESS FOR MINERALIZING DRINKING WATER USING A VERTICAL MANIFOLD

(71) Applicant: CORE PACIFIC INC., Houston, TX (US)

(72) Inventor: Patrick GWEN, Houston, TX (US)

(21) Appl. No.: 18/471,494

(22) Filed: Sep. 21, 2023

Related U.S. Application Data
(63) Continuation-in-part of application No. 18/175,998, filed on Feb. 28, 2023.
Application No. 18/175,998 is a continuation of application No. 17/815,479, filed on Jul. 27, 2022, now Pat. No. 11,597,669.

(51) Int. Cl. C02F 9/00

(52) U.S. Cl. CPC C02F 9/00; C02F 1/003

(57) ABSTRACT

An apparatus for mineralizing water has a housing having a filter positioned therein, a container receptacle assembly affixed to or formed on the housing, a pump cooperative with the container receptacle assembly and adapted to draw a mineral or supplement from a bottle in the container receptacle assembly, and a manifold positioned in the housing and connected to an outlet of the pump so as to receive the drawn mineral or supplement from the bottle by the first pump. The filter is adapted to filter the tap water of at least some particles or contaminants. The manifold mixes the drawn mineral or supplement and the filtered water therein. The manifold extends in a vertical orientation within the housing.

### CROSS-REFERENCE TO RELATED APPLICATIONS

The present application is a continuation-in-part of U.S. application Ser. No. 18/175,998, filed on Feb. 28, 2023, presently pending. U.S. patent application Ser. No. 18/175,998 is a continuation of U.S. application Ser. No. 17/815,479, filed on Jul. 27, 2022, now issued as U.S. Pat. No. 11,597,669 on Mar. 7, 2023.

### FIELD OF THE INVENTION

The present invention relates to water filter and mineralization assemblies. More particularly, the present invention relates to water filter assemblies or minerals are added to filtered water. More practically, the present invention relates to manifolds for the mixing of tap water with minerals or supplements prior to being dispensed as a drinking water.

### BACKGROUND OF THE INVENTION

In the art of water treatment, it is well-known to purify water for human consumption by implementing specific purifying processes. These purifying processes included, for example, the processes of filtration, sediment, bacterial digestion, distillation or reverse osmosis. In reverse osmosis, for example, a volume of liquid containing contaminants is introduced into a chamber on one side of a semi-permeable membrane (i.e. having pores large enough to pass the molecules of the liquid but not those of the solute contaminant). By pressurizing the liquid above its osmotic pressure, the liquid molecules will diffuse across the membrane but the solute molecules will remain. The resulting brine is then discarded and the liquid is thus purified and retained.

Such reverse osmosis systems can be configured to produce purified water from virtually any source and remove many of the contaminants contained therein, including dissolved mineral ions, with great effectiveness. While this is advantageous for many reasons and in many applications, it is nonetheless imperfect for the production of drinking water. Specifically, in the case of a reverse-osmosis process, it is not selective. In other words, it removes all dissolved mineral ions, both those which are desirable for health and taste along with those which are not. In the end, the produced water is a demineralized water free of any mineral ions.

It is therefore known to pass the demineralized water through a subsequent step for replenishing certain minerals lost and adding other desirable minerals not present in the water prior to the start of the purification process. In particular, calcium, magnesium and bicarbonate are particularly desirable. Their presence in drinking water may contribute to establishing and maintaining physical and mental health. These ions are also partly responsible for creating a pleasant taste in the drinking water.

One such means of doing this is to dissolve a mixture of mineral salts into the water. Commonly employed additives include calcium chloride, magnesium sulphate, chloride, bicarbonate of sodium, or potassium. However, the use of such salts will result in the presence of unwanted chloride, sulfate, sodium and potassium ions which can negatively affect the taste of water and bring a bitter and/or salty taste in the final product. At certain quantities, these can have deleterious effects on the health of certain sensitive customers (i.e. for people having specific diets, for example).

In the past, the minerals that are to be introduced into the filtered water are provided in a pellet form. Typically, the minerals are encapsulated in clay which slowly dissolves as the minerals are dissolved into the water. Unfortunately, the quality control of such mineral-bearing clay pellets is often inconsistent and quality control is minimal. As a result, the quality of the minerals, the quantity of the minerals, and the rate of mineral diffusion in the drinking water can be relatively uncontrolled. Under certain circumstances, the initial water washing across the mineral-bearing clay pellets will have a large amount of minerals therein. Later passages of water across the mineral-bearing clay pellets will have a lower mineral content. As such, the exact dosing of minerals into the drinking water is unavailable in the prior art.

It is the goal of the remineralization process to re-mineralize demineralized water with ions and minerals so as to establish and maintain physical and mental health while avoiding the undesirable ones for taste or health issues. It is therefore desirable to provide a means for re-mineralizing demineralized water with desirable ions, without also adding undesirable amounts, counter-ions and/or compounds.

During the process of adding minerals to filtered tap water, it is important to be able to uniformly and completely mix the minerals or supplements with the tap water. Under certain circumstances where a horizontal manifold would be used, the horizontal nature of the manifold can often result in incomplete filling of the manifold and can produce inconsistencies in the mineralized output from the manifold. For example, the minerals or supplements could be more dense than the tap water and can, as a result, reside more closely to a bottom wall of the manifold. Additionally, under those circumstances where the manifold is relatively thin, the amount of time required to fill the manifold from the bottom to the top in a horizontal manifold is relatively short. As such, an incomplete mixing of the minerals or supplements with the tap water is not able to be achieved. As such, a need is developed so as to provide a manifold for such a water mineralization system that effects a more complete and consistent mixture of minerals and supplements with the tap water.

In the past various patents and publications have issued with respect to the mineralization of drinking water. For example, U.S. Patent Application Publication No. 2018/0370826, published on Dec. 27, 2018 to Sublet et al., teaches a method and apparatus for providing re-mineralized water. In particular, this method includes the steps of providing a flow of feedwater and purifying and/or demineralized it by a purifying and/or demineralizing process to produce a flow of purified, demineralized water. Carbon dioxide is injected into the purified, demineralized water to provide a flow of carbon dioxide-enriched water. The carbon dioxide-enriched water is then passed through a re-mineralizer which comprises a dolomite medium. This produces a simultaneous remineralization of the water with calcium and magnesium and thus leads to a flow of purified, re-mineralized water.

U.S. Patent Application Publication No. 2020/0055753, published on Feb. 20, 2020 to Minor et al., teaches a water treatment system for treating and distributing water. The system includes a first container and an input conduit that supplies water (both purified and unpurified) to the first container. The system also has a treatment delivery system that delivers a mineral composition into the first container. The system uses a controller to selectively deliver the mineral composition into the first container so that the mineral composition mixes with and dissolves in the water delivered to the first container. This produces treated water having a desired to profile.

European Patent Application No. EP 3 831 468, published on Jun. 9, 2021 to M. Philiburt, discloses a process for providing mineralized drinking water. In particular, this is directed toward providing drinking water from polluted fresh or brackish water.

U.K. Patent Application Serial No. 2590533, published on Jun. 30, 2021 to A. Levy, provides a system and process of mineralizing distilled water with a replenishment of old mineral concentrates solutions. The system comprises a splitter for splitting distilled water into primary and secondary portions. First and second conduits convey the primary and secondary portions, respectively. A column having a mineral matrix is connected to the second conduit to generate a mineralizing concentrate solution. A mixing module is provided for combining a predefined amount of the mineralized concentrate solution with the primary portion of distilled water in order to form a mineralized water mixture. A dispensing module dispenses the mineralized water mixture. A carbonator is connected to the secondary conduit for dissolving carbon dioxide in the secondary portion of the distilled water.

International Publication No. WO 2007/010549, published on Jan. 25, 2007 to M. Gupta, discloses a household reverse osmosis-based drinking water purifier. This purifier has controlled natural mineral content in the purified water. There is a means for subjecting the raw water to reverse osmosis purification to provide treated demineralized water. There is a means for controlled natural mineral incorporation in the demineralized water by purifying the water through OF and/or UV treatment so as to provide for a reverse osmosis-treated and controlled natural mineral content purified water.

International Publication No. WO 2020/127612, published on Jun. 25, 2020 to Wagemanns et al., provides a method and apparatus for producing potable mineralized water. In particular, this method and apparatus uses a cartridge containing a mineral composition. The method includes providing a liquid to be treated to an apparatus for producing the potable mineralized water and adding a carbon dioxide precursor to the liquid. At least a portion of the carbon dioxide precursor is triggered to release carbon dioxide in order to provide carbon dioxide to the liquid. At least parts of the liquid are contacted with a mineral composition such that the mineral composition at least partially dissolves into the liquid in order to provide the potable mineralized water.

International Publication No. WO 2021/234709, published on Nov. 25, 2020 to Makmel et al., discloses a system and method for differential enrichment of water. In particular, this provides for specifically controlled admission of minerals and other nutrients into untreated water or water that has been preliminarily treated in order to selectively remove contaminants therefrom and to provide a desired nutrient profile in the water for use and consumption.

It is an object of the present invention to provide a water mineralization system that effectively re-mineralizes water.

It is another object of the present invention to provide a mineralization system that produces a healthy water output.

It is another object of the present invention to provide a mineralization system that consistently introduces minerals into water.

It is another object of the present invention to provide a mineralization system that provides consistent dosing of the minerals into the water.

It is another object of the present invention to provide a mineralization system that is convenient and easy to use.

It is another object of the present invention to provide a mineralization system that allows the user to set the rate and type of dosing.

It is another object of the present invention to provide a mineralization system which has a precise output.

It is still a further object of the present invention to provide a manifold for a mineralization system wherein a more complete mixing of water and minerals is achieved.

It is still a further is still further object of the present invention to provide a manifold for a mineralization system which occupies a minimal footprint within a housing.

These and other objects and advantages of the present invention will become apparent from a reading of the attached specification and appended claims.

### BRIEF SUMMARY OF THE INVENTION

The present invention is an apparatus an apparatus for mineralizing water. The apparatus comprises a housing having a filter positioned therein, a container receptacle assembly affixed to or formed on the housing and adapted to receive a bottle containing a mineral or supplement therein, a pump cooperative with the container receptacle assembly and adapted to draw the mineral or supplement from the bottle, and a manifold positioned in the housing and connected to an outlet. A first pump pumps the drawn mineral or supplement from the bottle. The filter is adapted to filter the tap water of at least some particles and contaminants. The manifold is connected to the filter so as to receive the filtered tap water therein. The manifold is adapted to mix the drawn mineral or supplement and the filtered water therein. The manifold has an outlet adapted to pass the mixture of the drawn mineral or supplement and filtered tap water outwardly the manifold. In the preferred embodiment of the present invention, the manifold extends in a vertical orientation within the housing.

The pump has a line connected adjacent to a bottom of the manifold. The filter is aligned with and extends toward the manifold. The line from the filter is also connected adjacent to the bottom of the manifold. The outlet of the manifold is located in an upper portion of the manifold. The mixture of the drawn mineral or supplement in the filtered tap water occurs as the mixture rises in the manifold toward the outlet of the manifold.

In the present invention, an ionizer can be positioned in the housing and connected to the outlet of the manifold. This ionizer is adapted to hydrogenate the mixture of the drawn mineral or supplement and the filtered tap water. The ionizer has an outlet adapted to pass the hydrogenated mixture outwardly of the housing.

A second pump is cooperative with the flow of the tap water so as to direct the tap water toward the filter. The filter can include a reverse osmosis filter. The reverse osmosis filter is adapted to separate a brine and a pure water from the filtered tap water. The reverse osmosis filter has line connected thereto. The line of the reverse osmosis filter is connected adjacent to the bottom of the manifold.

The filter can also comprise a pretreatment filter. The pretreatment filter is in communication with an inlet of the reverse osmosis filter. The pretreatment filter removes particles or contaminants from the tap water prior to passing to the reverse osmosis filter. The pump can also comprise a peristaltic pump configured to draw the mineral or supplement from the bottle in the container receptacle assembly. The pump can also comprise a diaphragm pump configured to pressurize the filtered tap water prior to passing to the reverse osmosis filter.

The present invention is also a process for mixing a mineral or supplement with filtered tap water. This process comprises the steps of: (1) providing a manifold having a first inlet and a second inlet and an outlet; (2) passing the filtered tap water into the first inlet of the manifold and into an interior of the manifold; (3) passing the mineral or supplement into the second inlet of the manifold; (4) filling the manifold with the filtered tap water from the first inlet in the mineral or supplement from the second inlet so as to mix the filtered tap water and the mineral or supplement within the interior of the manifold; and (5) discharging the mixture of the filtered tap water and the mineral or supplement from the outlet of the manifold.

The manifold is positioned vertically within a housing. The first inlet and the second inlet are positioned generally adjacent the bottom of the manifold. The outlet is positioned generally adjacent an upper portion of the manifold.

The filtered tap water is mixed with the mineral or supplement as the filtered tap water and the mineral or supplement rise within the manifold.

The filtered tap water can be pretreated so as to remove particles and contaminants therefrom in order to produce the filtered tap water as an output of the pretreatment filter. The filtered tap water is passed from the pretreatment filter to a reverse osmosis filter. The reverse osmosis filter produces a pure water output and a brine output. The pure water output passes to the first inlet of the manifold. The brine is discharged from the reverse osmosis filter away from the manifold.

The discharged mixture from the outlet of the manifold can be ionized so as to produce a hydrogenated water output. The mineral or supplement from a bottle is pumped toward the second inlet of the manifold. The filtered tap water is pumped toward the first inlet of the manifold. The process of the present invention further includes loading a bottle containing the mineral or supplement into the container receptacle assembly. The mineral or supplement is drawn from the bottle prior to passing to the second inlet of the manifold.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is an upper perspective view of the water mineralization system of the present invention.

FIG. 2 is a front end view of the water mineralization system of the present invention with the covers removed therefrom.

FIG. 3 is an upper perspective view of the water mineralization system of the present invention showing the interior of the housing and the equipment within the interior of the housing.

FIG. 4 is an upper perspective view showing the water treatment components associated with the water mineralization system of the present invention.

FIG. 5 is a side elevational view showing the manifold as used in the present invention.

### DETAILED DESCRIPTION OF THE INVENTION

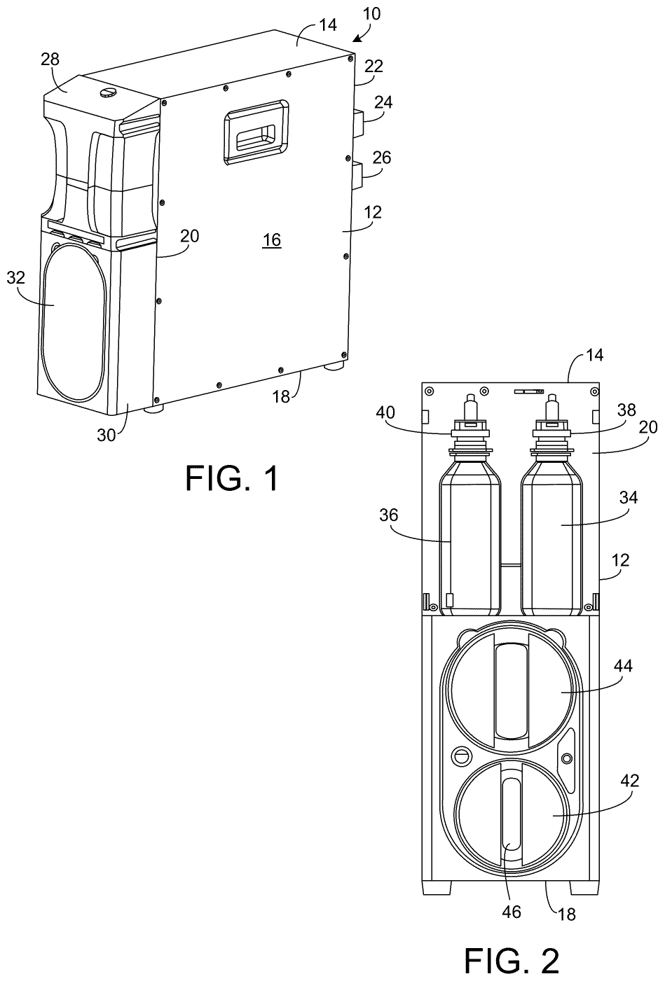

Referring to FIG. 1, there shown the water mineralization system 10 in accordance with the teachings of the present invention. The water mineralization system 10 includes a housing 12 having a generally rectangular cubicle configuration. In particular, housing 12 has upper surface 14, side wall 16, bottom 18, front wall 20 and back wall 22. Walls 14, 16, 18 and 20 enclose the assembly for the treatment of water. In particular, in FIG. 1, the back wall 22 includes an inlet connection 24. Inlet connection 24 is adapted to allow tap water to be introduced into the interior of the housing 12. A support 26 is illustrated below the inlet 24. Support 26 is configured so as to support a line extending for the introduction of tap water into the housing 12. An outlet for the mineralized drinking water is positioned on a side of the inlet 24 (not shown in FIG. 1).

In FIG. 1, it can be seen that there is a first cover 28 that is positioned against the front wall 20 of the housing 12. This first cover 28 extends over the mineral or supplement-containing bottles used in the dosing of minerals into the drinking water. Cover 28 is removably positioned adjacent to the upper surface 14 of the housing 12. A second cover 30 is positioned against the front wall 20 of the housing 12 and extends so as to be positioned generally adjacent to the bottom 18 of the container 12. Second cover 30 is intended to removably cover the filters contained within the housing 12. In particular, second cover 30 can include a flap or surface 32 that can be specifically removed from the cover 30 so as to allow direct access to the filters within the housing 12.

FIG. 2 shows the configuration at the front wall 20 of the housing 12. In FIG. 2, it can be seen that there is a first bottle 34 and a second bottle 36 that are positioned adjacent to the top 14 of housing 12. Each of the bottles 34 and 36 are connected to container receptacle assemblies 38 and 40. The bottles 34 and 36 are removably connected respectively to the container receptacle assemblies 38 and 40. The bottles 34 and 36 can contain minerals and/or supplements therein. In particular, one of the bottles can contain one type of mineral and the other bottle can contain another type of mineral. As such, through a control system, the filtered drinking water can be dosed with a desired quantity of the minerals or supplements from bottle 34 and a desired quantity of the minerals or supplements from bottle 36. If necessary, the control system can be actuated so as to prevent any of the minerals in either of the bottles 34 and 36 from entering the system. The controls can also be adapted to control the rate at which the minerals pass from the bottles 34 and 36 into the filtered water within the interior of the housing 12.

FIG. 2 shows the front wall 20 of the housing 12 with the second cover 30 removed. The removal of the second cover 30 exposes a first filter 42 and a second filter 44. The end of the first filter 42 is exposed at the front wall 20 so that the handle 46 of first filter 42 can be accessed. As such, if it is desired to remove or repair the first filter 42, it is only necessary to remove the cover 30 (or flap 32), access the handle 46, rotate the handle 46 and slide the first filter 42 out of position. A similar action can occur with respect to the second filter 44.

The first filter 42, in the preferred embodiment of the present invention, is a pretreatment filter or a carbon filter. In the preferred embodiment the present invention, the second filter 44 is a reverse osmosis filter. When the first filter 42 is a pretreatment filter, the tap water entering the inlet 24 of the housing 12 will flow in this pretreatment filter so that the pretreatment filter can provide an initial treatment to the water and remove sediment and other contaminants therefrom. The water will flow from the pretreatment filter 42 into the reverse osmosis filter 44 for further removal of any metals, chemicals, contaminants or ions from the water. Importantly, each of the first filter 42 and second filter 44 is located adjacent to the bottom 18 of the housing 12. The first filter 42 and the second filter 44 are also located below the bottles 34 and 36 and located below the container receptacle assemblies 38 and 40. This arrangement greatly improves efficiency in terms of the management of the filters and the bottles. The ease of accessibility of the filters 42 and 44 greatly improves efficiency in the water treatment process and the repair or replacement of the filters.

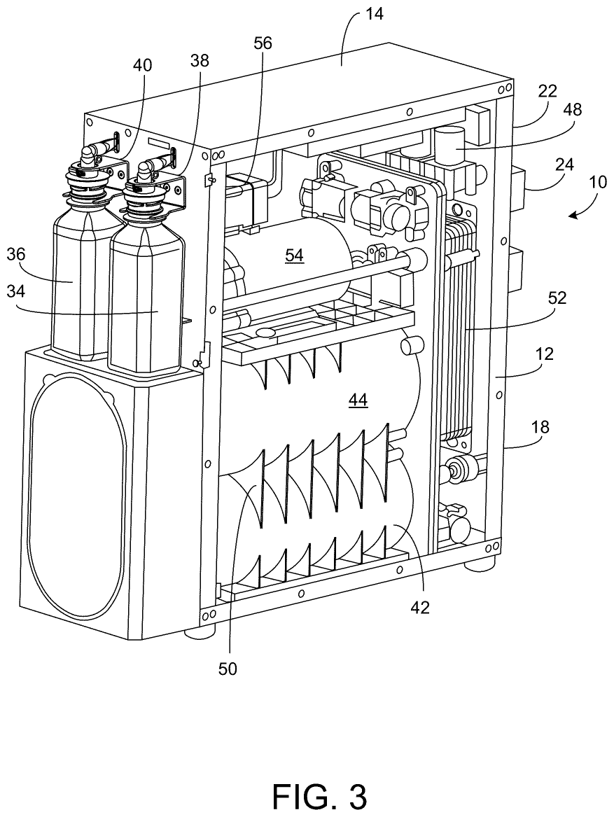

FIG. 3 further shows the water mineralization system 10 of the present invention. In particular, FIG. 3 shows that the inlet 24 at the back wall 22 of housing 12 has a valve 48 associated therewith. Valve 48 is movable between an open position and a closed position. In the closed position, tap water flow into the interior of housing 12 is blocked. In the open position, tap water flow into the interior of the housing 12 is permitted. The valve 48 is easily accessible so as to allow water flow to be immediately turned off in the event that leaks should occur or in the event that leak detection equipment within the interior of the housing 12 should signal a leak. The present invention avoids the need to locate the source of the water flow in order to stop the water flow to the water mineralization system 10.

In FIG. 3, it can be seen that the first filter 42 and the second filter 44 extend longitudinally across the housing 12. Various brackets 50 support these filters in their desired position. A manifold 52 is illustrated as positioned adjacent to the back wall 18 of the housing 12. Manifold 52 extends in a generally vertical orientation. The manifold 52 is positioned between the first and second filters 42 and 44 and the back wall 18. Manifold 52, as will be explained hereinafter, serves to receive the flow of the mineral or supplement-containing liquid as pumped from the bottles 34 and 36 and mixes this mineral-containing liquid in the manifold 52 with the filtered water from the first and second filters 42 and 44. As can be seen, the manifold 52 extends vertically within the interior of the housing 12. As such, it occupies a relatively small footprint within the interior of the housing 12. The manifold 52 is positioned generally adjacent an end of the first filter 52 and the second filter 54 opposite the container receptacle assembly. The manifold 52, as will be described hereinafter, is adapted to receive the filtered tap water output of the first filter 42 and the second filter 44 at a location generally adjacent to a bottom of the manifold. 52. The mineral or supplement from the bottles 34 and 36 of the container receptacle assembly are connected by a line so as to be introduced into the manifold 52 generally adjacent to the bottom of the manifold. 52. The manifold 52 will have an outlet generally adjacent to the top thereof. This outlet is directed toward an ionizer 53. Ionizer 53 is positioned generally adjacent to the wall 18 of the housing 12. Ionizer 53 is intended to hydrogenate the mixture of a filtered tap water and the mineral or supplement as passed from the manifold. 52.

Since it is necessary to pressurize the pre-treated water in order to have the pretreated water flow through the reverse osmosis filter 44, a diaphragm pump 54 is positioned in the interior of housing 12. Diaphragm pump 54 will receive the pretreated water from the first filter 42, pressurize the water, and then pass the water, under pressure, through the second filter 44 (the reverse osmosis filter). The filtrate from the second filter 44 can then flow into the bottom of the manifold 52 for the purposes of mixing the minerals with the demineralized water.

In the present invention, it is very important to control the rate and amount of the mineral or supplement-containing liquid from the bottles 34 and 36 that enters the filtered water. As such, a peristaltic pump 56 is used in association with each of the bottles 34 and 36. Peristaltic pump 56 operates in a conventional manner so as to assure the delivery of a desired quantity or rate of mineral-containing liquid toward the bottom of the manifold 52. Peristaltic pumps, as they are known, utilize flexible tubes and rollers so as to pass a fixed amount of fluid flow. The peristaltic pump 56 avoids the use of any valves. Suitable servomotors can be utilized in conjunction with the peristaltic pump 56 so as to control the rate at which the mineral-containing liquid is discharged into the manifold 52.

FIG. 3 further shows that the water mineralization system 10 has special container receptacle assemblies 38 and 40 positioned adjacent to the top 14 of housing 12. Peristaltic pump 56 is positioned on the interior of housing 12 and adjacent to these container receptacle assemblies 38. The close positioning of the peristaltic pump 56 to the container receptacle assemblies 38 and 40 assures the proper operation of the peristaltic pump and the proper delivery of fluid from the bottles 34 and 36. If the peristaltic pump 56 were not positioned adjacent to the container receptacle assemblies 38 and 40, there could be more dosing error associated with the delivery of the mineral-containing liquid from the bottles 34 and 36.

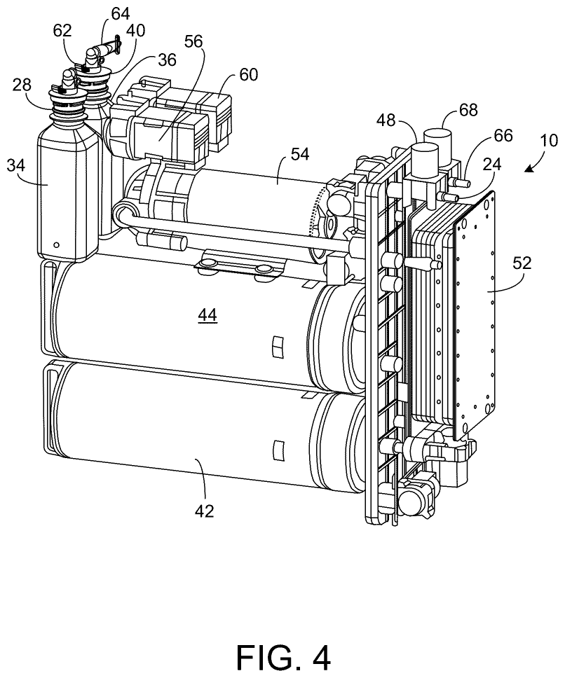

FIG. 4 shows the interior of the water mineralization system 10 of the present invention. In particular, FIG. 4 shows the first filter 42 and the second filter 44 arranged one on top of another adjacent to the bottom of the housing. Bottles 34 and 36 are positioned adjacent to the top of the housing. The peristaltic pump 56 is positioned adjacent to the container receptacle assembly 38. Peristaltic pump 60 is positioned adjacent to the container receptacle assembly 40. A line or conduit will extend from the elbows 62 and 64 of the respective container receptacle assemblies 38 and 40 to the respective peristaltic pumps 56 and 60.

FIG. 4 shows the configuration of the inlet 24 and the outlet 66. Inlet 24 receives the tap water into the interior of the housing. Outlet 66 allows for the discharge of mineralized drinking water from the housing. Valve 48 extends outwardly from the inlet 24 and operates to control the flow of water through the inlet 24. Valve 68 is associated with the outlet 66 and can control the flow of mineralized drinking water out of the outlet 66. Initially, the tap water will flow through the inlet 24 and down to the first filter 42 for pretreatment purposes. The outlet of the first filter 42 will flow to the diaphragm pump 54 for pressurization prior to passing to the second filter 44 (the reverse osmosis filter). Ultimately, the filtered water from the reverse osmosis filter 44 will be devoid of minerals. It can then flow into the manifold 52 for mixing with a mineral-containing liquid from bottles 34 and 36. After mixing, the manifold 52 will then pass the flow of the mineralized drinking water to the outlet 66. The manifold 52 can be connected to the outlet 66 of the housing 12 or it can be the outlet of the housing 12.

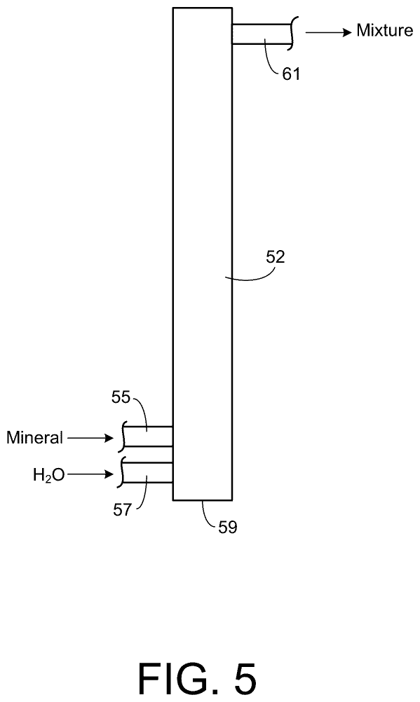

FIG. 5 shows a simplified view of the manifold 52. As can be seen, the manifold 52 extends in a vertical orientation and has a relatively large height-to-width ratio. As can be seen, the supplement or minerals from the bottles can enter through an inlet 55. The filtered tap water can enter through the manifold 52 through an inlet 57. Inlet 55 and inlet 57 are generally located adjacent to the bottom 59 of the manifold 52. The manifold 52 will have an interior volume into which the mineral or supplement and the filtered tap water can be introduced. FIG. 5 shows the inlet 55 for the mineral as located above the inlet 57 for the water. This is simply a matter of convenience and illustration. In normal use, the inlet 55 can be positioned at the same level as the inlet 57 and generally adjacent to the bottom 59 of the manifold 52.

Importantly, in the present invention, the introduction of the mineral or supplement and the filtered tap water into the interior of the manifold 52 causes the mixing of the mineral with the water to occur immediately upon introduction. As the flow of the mineral or supplement and the flow of the filtered tap water continues to flow into the manifold 52, it will thoroughly mix as the mixture rises within the interior of the manifold 52. Ultimately, this mixture will continue to rise until it reaches the level of the outlet 61. This thorough mixture of the mineral or supplement with the filtered tap water can then be discharged from the manifold 52 through the outlet 61. This mixture can then flow to the ionizer 53 and/or to the outlet of the housing.

This configuration of the manifold 52 assures the complete filling of the interior of the manifold 52 by gravity. As such, all gaps, grooves or fins within the manifold 52 will be completely filled without spaces. The filling the manifold 52 with a mineral or supplement and a filtered tap water can occur without turbulence. As such, the mixture occurs very consistently and completely during the travel of the mixture from the bottom 52 toward the outlet 61. Since the manifold 52 is relatively thin (in comparison with its width), the manifold 52 will occupy a minimal amount of space within the housing of the water mineralization system (as shown in FIGS. 3 and 4).

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

I claim:

1. An apparatus for mineralizing water, the apparatus comprising:
a housing having a filter positioned therein, said housing having an inlet adapted to pass tap water into said housing, the filter adapted to filter the tap water of at least some particles or contaminants therefrom;
a container receptacle assembly affixed to or formed on said housing, said container receptacle assembly adapted to receive a bottle containing a mineral or supplement therein;
a pump cooperative with said container receptacle assembly, said pump adapted to draw the mineral or supplement from the bottle; and
a manifold positioned in said housing and connected to an outlet of said pump so as to receive the drawn mineral or supplement that was drawn from the bottle by the pump, said manifold connected to the filter so as to receive the filtered tap water therein, said manifold adapted to mix the drawn mineral or supplement and the filtered water therein, said manifold having an outlet adapted to pass the mixture of the drawn mineral or supplement and filtered tap water outwardly said manifold.

2. The apparatus of claim 1, said manifold extending in a vertical orientation within said housing.

3. The apparatus of claim 2, said pump having a line connected adjacent to the bottom of said manifold.

4. The apparatus of claim 3, said filter having a line extending to said manifold, said line from said filter being connected adjacent to the bottom of said manifold.

5. The apparatus of claim 4, the outlet of said manifold located in the upper portion of said manifold, wherein the mixing of the drawn mineral or supplement and the filtered water tap water occurs as the mixture rises in said manifold toward the outlet of said manifold.

6. The apparatus of claim 1, further comprising:
an ionizer positioned in said housing and connected to the outlet of said manifold, said ionizer adapted to hydrogenated the mixture of the drawn mineral or supplement and the filtered water, the ionizer having an outlet adapted to pass the hydrogenated mixture outwardly of said housing.

7. The apparatus of claim 1, further comprising:
another pump cooperative with a flow of the tap water so as to direct tap water toward the filter.

8. The apparatus of claim 7, wherein the another filter comprises a reverse osmosis filter, the reverse osmosis filter adapted to separate a brine and a pure water from the tap water.

9. The apparatus of claim 8, reverse osmosis filter having a line connected thereto, the line of said reverse osmosis filter being connected adjacent to the bottom of said manifold.

10. The apparatus of claim 8, wherein the filter comprises a pretreatment filter, the pretreatment filter being in communication with an inlet of the reverse osmosis filter, the pretreatment filter removing the particles or contaminants from the tap water prior to passing to the reverse osmosis filter.

11. The apparatus of claim 10, wherein said pump comprises a peristaltic pump configured to draw the mineral or supplement from the bottle in said container receptacle assembly and a diaphragm pump configured to pressurize the filtered tap water prior to entering the reverse osmosis filter.

12. A process for mixing a mineral or supplement with filtered tap water, the process comprising:
providing a manifold having a first inlet and a second inlet and an outlet;
passing the filtered tap water into the first inlet of the manifold and into an interior of the manifold;
passing the mineral or supplement into the second inlet of the manifold;
filling the manifold with the filtered tap water from the first inlet and the mineral or supplement from the second inlet so as to mix the filtered tap water and the mineral or supplement within the interior of the manifold; and
discharging the mixture of the filtered tap water and the mineral or supplement through the outlet of the manifold.

13. The process of claim 12, further comprising:
positioning the manifold vertically within a housing, wherein the first inlet and the second inlet are positioned generally adjacent a bottom of the manifold, the outlet being positioned generally adjacent an upper portion of the manifold.

14. The process of claim 13, wherein the step of filling comprises:
mixing the filtered tap water with the mineral or supplement as the filtered tap water and the mineral or supplement rise within the manifold.

15. The process of claim 12, wherein the step of passing the filtered tap water comprises:
pretreating tap water so as to remove particles and contaminants from the tap water so as to produce the filtered tap water as an output of the pretreatment filter.

16. The process of claim 15, further comprising:
passing the filtered tap water from the pretreatment filter to a reverse osmosis filter; and
producing a pure water output and a brine output from the reverse osmosis filter, wherein the pure water output passes to the first inlet of the manifold.

17. The process of claim 16, further comprising:
discharging the brine output from the reverse osmosis filter away from the manifold.

18. The process of claim 12, further comprising:
ionizing the discharged mixture from the outlet of the manifold so as to produce a hydrogenated water output.

19. The process of claim 12, further comprising:
pumping the mineral or supplement from a bottle toward the second inlet of the manifold; and
pumping the filtered tap water toward the first inlet of the manifold.

20. The process of claim 12, further comprising:
loading a bottle containing the mineral or supplement into the container receptacle assembly, the step of passing the mineral or supplement comprising:
drawing the mineral or supplement from the bottle prior to passing to the second inlet of the manifold.
